(19) United States
(12) Patent Application Publication
(10) Pub. No.: US 2015/0297319 A1
(43) Pub. Date: Oct. 22, 2015

(54) Vibrator For Tooth Movement Modulation

(71) Applicant: Indiana University Research & Technology Corporatin, Indianapolis, IN (US)

(72) Inventors: Jie Chen, Carmel, IN (US); Zeyang Xia, Shenzhen (CN)

(21) Appl. No.: 14/382,906

(22) PCT Filed: Mar. 4, 2013
(86) PCT No.: PCT/US13/28864

§ 371 Date: Sep. 4, 2014

Related U.S. Application Data
(60) Provisional application No. 61/612,745, filed on Mar. 19, 2012.

(51) Int. Cl. A61C 7/00; A61C 1/07; A61C 1/12; A61C 1/00

(52) U.S. Cl. CPC A61C 7/008; A61C 1/0015; A61C 1/07; A61C 1/12

(57) ABSTRACT

A handheld orthodontic tool includes a housing, electric motor, and a probe configured to engage a tooth. An operator applies manual pressure to the tooth with the probe, and the electric motor activates to vibrate the tooth through the probe. The orthodontic tool enables accelerating individual tooth or a group of teeth during orthodontic treatment to reach differential tooth movement speed, which will shorten the treatment time and reduce side effects including root resorption and anchorage loss.

### CLAIM OF PRIORITY

This application claims priority from U.S. Provisional Application No. 61/612,745, which is entitled “VIBRATOR FOR TOOTH MOVEMENT MODULATION,” and was filed on Mar. 19, 2012.

### TECHNICAL FIELD

The present disclosure relates generally to devices for use in orthodontia, and, more specifically, to devices for moving teeth during orthodontic treatment.

### BACKGROUND

In orthodontics, most of the treatments require moving teeth at different speeds. Ideally, anchorage teeth should not move and the moving teeth should displace quickly into the desired position. However, in reality, this movement is difficult to achieve. Tooth movement is initiated by a load system provided by orthodontic appliance. Normally, activation of the appliance results in an action force on the moving tooth and reaction forces on other teeth, which cause other teeth to move. For example, in a canine tooth retraction case, one of the strategies is to retract the canine tooth into the distal vacant space and keep the molars stationary (as the anchorage tooth). If a segmental wire is used to retract the canine tooth, due to action and reaction, activation of the wire not only retracts the canine tooth, but also forces the molars to move, resulting in a loss of anchorage.

Measures have been implemented to secure the anchorage using techniques, such as transpalatal arch (TPA), that bind the molars together or that add mini-implants to strengthen the anchorage. These techniques provide a certain level of success, but they also add a layer of complexity to the treatment. Some of these techniques, such as implants, are invasive. Other treatments also present similar challenges. Since reaction forces are inevitable, an alternative approach is needed. The question is whether sensitivity of an individual tooth or a group of teeth to orthodontic loads systems can be increased so that the teeth under the load system move faster than others. If the answer to this question is yes, then clinicians will be able to use a set of specially designed tools to accelerate the movement of tooth or teeth that they intend to move with reduced side effects, such as anchorage loss and root resorption, because these side effects are closely linked to the length of treatment time. Such clinical outcomes benefit both clinicians and patients greatly.

### SUMMARY

A new orthodontic tool improves orthodontic treatments that require differential tooth movement speed (DTMS). DTMS is desired in various orthodontic treatments, such as canine tooth retraction or space closure, where only a specific tooth or a group of teeth need to be moved. Previous research has shown that applying certain levels of vibrational force on a tooth accelerates the tooth movement under an orthodontic force. The orthodontic tool enables clinicians to accelerate specified target tooth or teeth movements by applying a vibrational force to the teeth to be moved with a certain frequency, intensity characterized as either force magnitude or amplitude of the vibration, and duration. The orthodontic tool provides orthodontists better control over movements of an individual tooth or group of teeth. Consequently, the orthodontic tool significantly reduces the treatment time and side-effects, such as root resorption, unwanted tooth displacement, and anchorage loss that can occur during prolonged orthodontic treatment. Shortening the treatment time also shortens the time for anchorage teeth to move, and reduces anchorage loss, which has been a major challenge in orthodontic treatment.

In one embodiment, an orthodontic tool has been developed. The orthodontic tool includes a housing, a probe extending from the housing that is configured to engage a tooth or a group of teeth, and an electric motor positioned in the housing, the electric motor being activated to vibrate the tooth or teeth through the probe.

### BRIEF DESCRIPTION OF THE DRAWINGS

FIG. 1A is a schematic diagram of an orthodontic tool that vibrates at least one tooth during orthodontic treatment.

FIG. 1B is an exploded schematic diagram of the orthodontic tool of FIG. 1A.

FIG. 2A is a schematic view of an adapter for the orthodontic tool of FIG. 1A that is configured to engage a maxillary canine, incisor, or premolar.

FIG. 2B is a schematic view of another adapter for the orthodontic tool of FIG. 1A that is configured to engage maxillary teeth.

FIG. 2C is a schematic view of another position of the adapter of FIG. 2B that is configured to engage maxillary teeth.

FIG. 2D is a schematic view of another adapter for the orthodontic tool of FIG. 1A that is configured to engage maxillary teeth.

FIG. 2E is a schematic view of another adapter for the orthodontic tool of FIG. 1A that is configured to engage maxillary teeth.

FIG. 2F is a schematic view of another adapter for the orthodontic tool of FIG. 1A that is configured to engage maxillary teeth.

FIG. 2G is a schematic view of another adapter for the orthodontic tool of FIG. 1A that is configured to engage maxillary teeth.

FIG. 3A is a schematic view of an adapter for the orthodontic tool of FIG. 1A that is configured to engage mandibular teeth.

FIG. 3B is a schematic view of an adapter for the orthodontic tool of FIG. 1A that is configured to engage mandibular teeth.

FIG. 3C is a schematic view of another position of the adapter of FIG. 3B that is configured to engage mandibular teeth.

FIG. 3D is a schematic view of an adapter for the orthodontic tool of FIG. 1A that is configured to engage mandibular teeth.

FIG. 3E is a schematic view of an adapter for the orthodontic tool of FIG. 1A that is configured to engage mandibular teeth.

FIG. 3F is a schematic view of an adapter for the orthodontic tool of FIG. 1A that is configured to engage mandibular teeth.

FIG. 3G is a schematic view of an adapter for the orthodontic tool of FIG. 1A that is configured to engage mandibular teeth.

FIG. 4A is a schematic view of an adapter for the orthodontic tool of FIG. 1A that is configured to engage multiple adapters to different teeth.

FIG. 4B is a detail schematic view of the adapter of FIG. 4A that is configured to engage multiple adapters to different teeth

### DETAILED DESCRIPTION

The description below and the accompanying figures provide a general understanding of the environment for the apparatus described herein as well as the details for use of the apparatus. In the drawings, like reference numerals are used throughout to designate like elements.

Various anatomical terms are used herein to describe the functions of the orthodontic tool with reference to the teeth of a patient. The term “lingual” refers to a side of a tooth that faces the tongue or to pressure applied to teeth in the direction of the tongue. The term “labial” refers to a side of a tooth that faces the lips. The term “buccal” refers to a side of a tooth that faces the cheek. The term “mesial” refers to a direction toward the mandibular symphysis, where the bones of the lower jaw are fused together at the front of the mouth. The term “distal” refers to a direction away from the mandibular symphysis (opposite the mesial). The term “vestibular” refers generally to the sides of the teeth that face away from the tongue, including the labial and buccal sides, or to a direction of pressure applied to teeth in a direction away from the tongue. The term “apical” refers to a direction along a length of a tooth pointing away from the jaw that anchors the tooth. The term “occlusal” refers to a direction along a length of a tooth pointing toward the jaw that anchors the tooth. The term “maxillary” refers to the upper jaw. The term “mandibular” refers to the lower jaw.

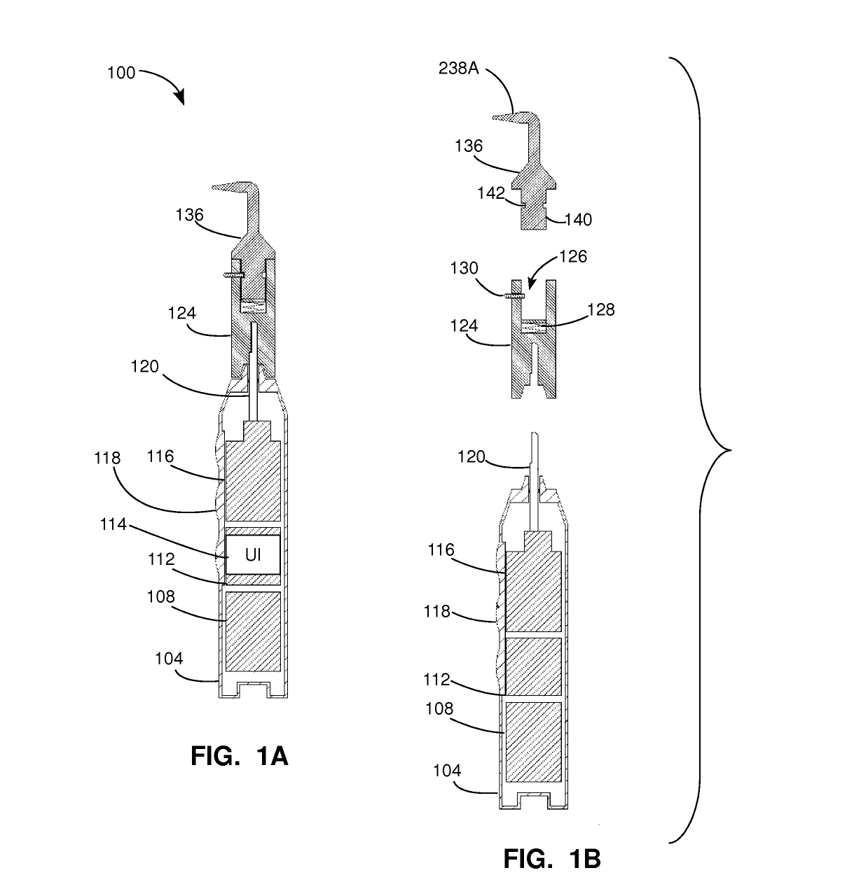

FIG. 1A and FIG. 1B depict a handheld orthodontic tool 100. The orthodontic tool 100 includes a base housing 104, connector 124, and a detachable adapter 136. The base housing 104 holds a battery 108, electronic control unit 112, and an electric motor 116. A contoured grip 118 is formed on a portion of the base housing 104 to provide a comfortable surface for an operator to hold the orthodontic tool 100 during use. The operator can be a medical professional or a patient who uses the device to apply pressure and vibrational force to one or more teeth during a course of orthodontic treatment. The pressure should be sufficient to ensure that the entire vibrational force is applied to a tooth or a group of teeth.

In the embodiment of FIG. 1A and FIG. 1B, the electric motor 116 is a direct current (DC) motor that resonates an output shaft 120. The output shaft 120 strikes the connector 124 as electric motor 116 resonates the output shaft, which generates vibrations in the connector 124. The vibrations are transferred through the connector 124 to a probe that is part of the adapter 136. When the adapter 136 engages one or more teeth, the vibrations are transferred to the teeth through the probe to promote movement of the teeth for orthodontic treatment. In FIG. 1A, the battery 108 supplies electrical power to the electronic control unit 112 and electrical motor 116. In another embodiment, the orthodontic tool 100 includes a power cord and receives electrical power from a standard electrical outlet supplying 110-240 VAC electrical energy at 50-60 Hz.

During operation, an operator holds the orthodontic tool 100 using one or two hands on the grip 118. The operator selects the intensity and frequency of vibration with a user interface (UI) 114. In one embodiment, the user interface 114 is a multi-position selector switch formed on the exterior of the base housing 104. The multi-position selector switch 114 is configured to generate a signal indicating a vibration frequency and intensity. The signal generated by the selector switch, or user interface, is operatively connected to the electronic control unit 112, which modulates the electrical power signal received from the electrical power source. The modulated electrical power signal is delivered to the electrical motor 116 to operate the motor at the selected frequency of vibration and intensity. The operator selects a vibrational frequency and intensity for the orthodontic tool with reference to the type of teeth that are being manipulated. For example, the operator selects a lower vibrational intensity level when manipulating incisor teeth, and selects a higher vibrational intensity level when manipulating molar teeth. In some operating modes, the electronic control unit 112 varies the electrical power provided to the electrical motor with reference to a programmed pattern stored in a memory of the electronic control unit 112.

The connector 124 engages the base housing 104. The output shaft 120 extends from the base housing 104 into the connector 124. The connector 124 includes a socket 126, spring 128, and retention member 130. The adapter 136 includes a base 140 and a retention groove 142. To connect the adapter 136 to the orthodontic tool 100, the base 140 is inserted with a downward force into the socket 126, compressing the spring 128. Rotation of the adapter 136 engages the retention member 130 with the retention groove 142 to secure the adapter 136 in place. During operation, the connector 124 transfers vibrational force from the output shaft 120 to the adapter 136. To remove the adapter 136, an operator disengages the retention member 130 to release the adapter 136. The operator then pulls the adapter 136 out of the socket 126. The spring 128 expands to urge the adapter 136 from the socket 126 to enable quick removal of the adapter 136 during use. As described below, various adapters can be connected to the orthodontic tool 100.

FIG. 1A and FIG. 1B depict an adapter 136 and exemplary probe 238A. The adapter 136 and probe 238A are formed from a single rigid support piece, such as a thermoplastic. The probe 238A is covered in a softer material, such as silicone rubber, to engage a tooth. The common adapter 136 enables use of a wide range of probes that are configured to engage one or more teeth with the orthodontic tool 100. An operator engages the adapter 136 of the appropriate probe to the orthodontic tool 100, and can switch between different probes quickly during orthodontic procedures.

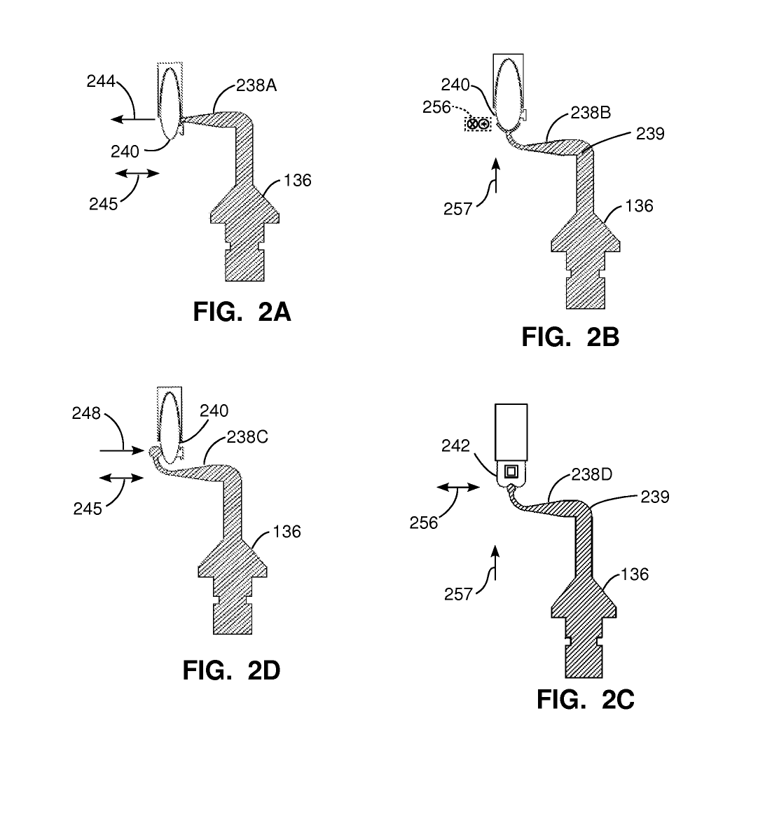

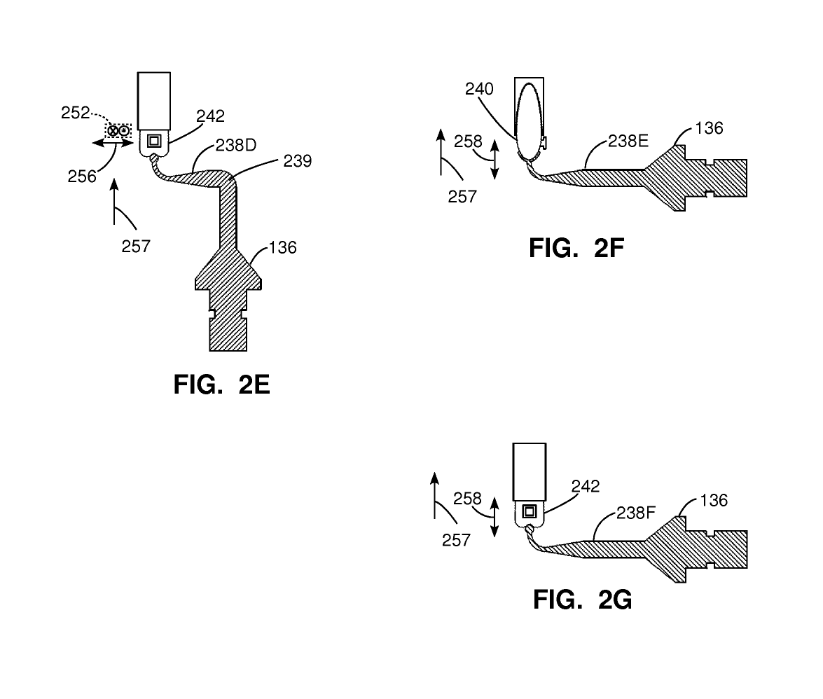

FIG. 2A-FIG. 2G depict different adapter configurations for adjusting the position of maxillary teeth. In FIG. 2A, the adapter 136 includes a probe 238A. The probe 238A and adapter136 bend at about a right angle to the output shaft of the electrical motor 116 to engage a tooth 240. In the example of FIG. 2A, the probe 238A is configured to terminate in a rounded tip to engage the vestibular sides of incisors, canines, and premolar teeth. When connected to the orthodontic tool 100, an operator pushes the probe 238A against the tooth 240 in the lingual direction 244. The adapter 136 and probe 238A transmit vibrations from the orthodontic tool 100 to the tooth 240. The tooth vibrates in the lingual and buccal directions 245 in response to the vibrations transmitted through the probe 238A.

In FIG. 2B another probe 238B also bends at about a right angle to the output shaft of the electrical motor 116 at an articulation 239 and then terminates in a curve and U-shaped end or cup to engage a lower edge of the tooth 240. The U-shaped end or a cap enables the orthodontic tool 100 to apply pressure on the tooth 240 in the apical direction 257 while the probe 238B applies vibration to the tooth in the mesial and distal directions 256. The adapter 136 approaches the canine or incisor teeth 240 and the U-shaped end or cap enables the probe 238B and adapter 136 to remain engaged to the tooth 240.

In FIG. 2C another probe 238D bends at about a right angle to the output shaft of the electrical motor 116 at an articulation 239 and then terminates in a curve having a rounded tip, which engages the occlusal surface of the molar 242. The engagement of the rounded tip with the occlusal surface of the molar enables the orthodontic tool 100 to apply pressure on the tooth 242 in the apical direction 257 while the probe 238D applies vibration to the tooth in the mesial and distal directions 256. The adapter 136 approaches the molar or premolar tooth 242 and the rounded tip of the probe 238D engages the occlusal surface of the molar or premolar tooth 242.

In FIG. 2D another probe 238C also bends at about a right angle to the output shaft of the electrical motor 116 and terminates in a hooked end and rounded tip to engage a lingual side of the tooth 240. The hooked end and tip of the probe 238C engages the tooth 240 while an operator pulls the orthodontic tool 100 in the buccal direction 248. The adapter 136 and probe 238C transmit vibrations from the orthodontic tool 100 to the tooth 240. The tooth vibrates in the lingual and buccal directions 245 in response to the vibrations transmitted through the probe 238C.

In FIG. 2E the probe 238D is configured to bend at about a right angle to the output shaft of the electrical motor 116 at articulation 239 and then curve into a rounded tip to engage a an interior of a cusp on the tooth 242. The rounded tip of the probe 238D engages the occlusal surface of the molar 242. The operator pushes the probe 238D in the apical direction 257 to engage the tooth 242. When engaged to the molar 242, an operator can push or pull on the orthodontic tool 100 in the lingual and buccal directions 252 and in the mesial and distal directions 256. The adapter 136 and probe 238D transmit vibrations from the orthodontic tool 100 to the tooth 242.

In FIG. 2F another probe 238E engages an incisor, canine, or premolar tooth 240. The probe 238E includes a U-shaped end or a cap to engage the crown of the tooth 240 in a similar manner to the probe 238B. The probe 238E, however, extends in the longitudinal axis along the length of the adapter 136 and the orthodontic tool 100 instead of including the articulation 239 in the probe 238B. The probe 238E enables the operator to apply manual pressure on the tooth 240 in the apical direction 257. The orthodontic tool 100 generates vibrational forces in the apical and occlusal directions 258, and the probe 238E transmits the vibrational forces to the tooth 240.

In FIG. 2G another probe 238F engages a molar tooth 242. The probe 238F includes a ball shaped end to engage the bottom of the tooth 242 in a similar manner to the probe 238D. The probe 238F, however, extends in the longitudinal axis along the length of the adapter 136 and the orthodontic tool 100 instead of including the articulation 239 in the probe 238D. The probe 238F enables the operator to apply manual pressure on the tooth 242 in the apical direction 257. The orthodontic tool 100 generates vibrational forces in the apical and occlusal directions 258, and the probe 238F transmits the vibrational forces to the tooth 242.

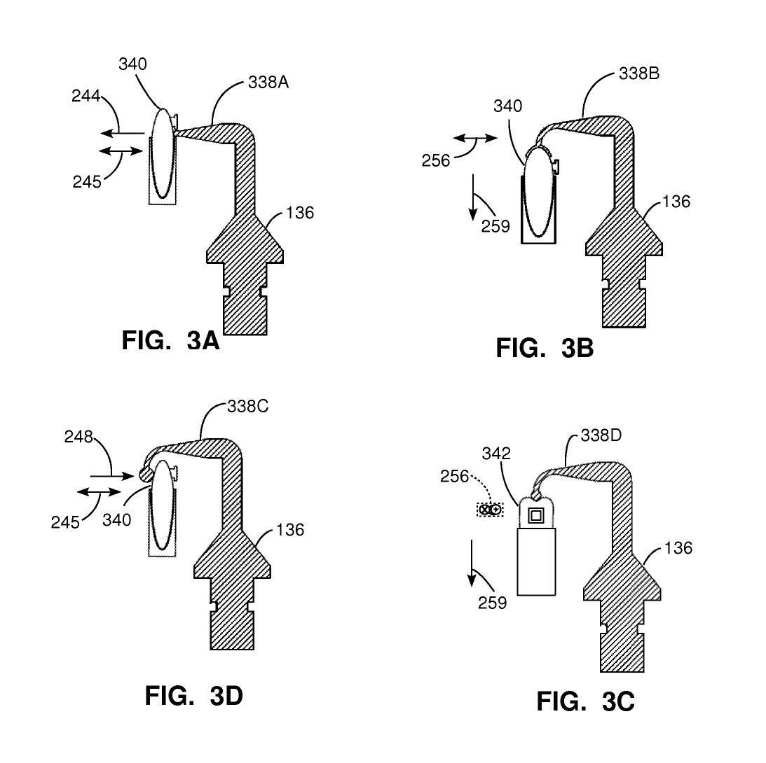

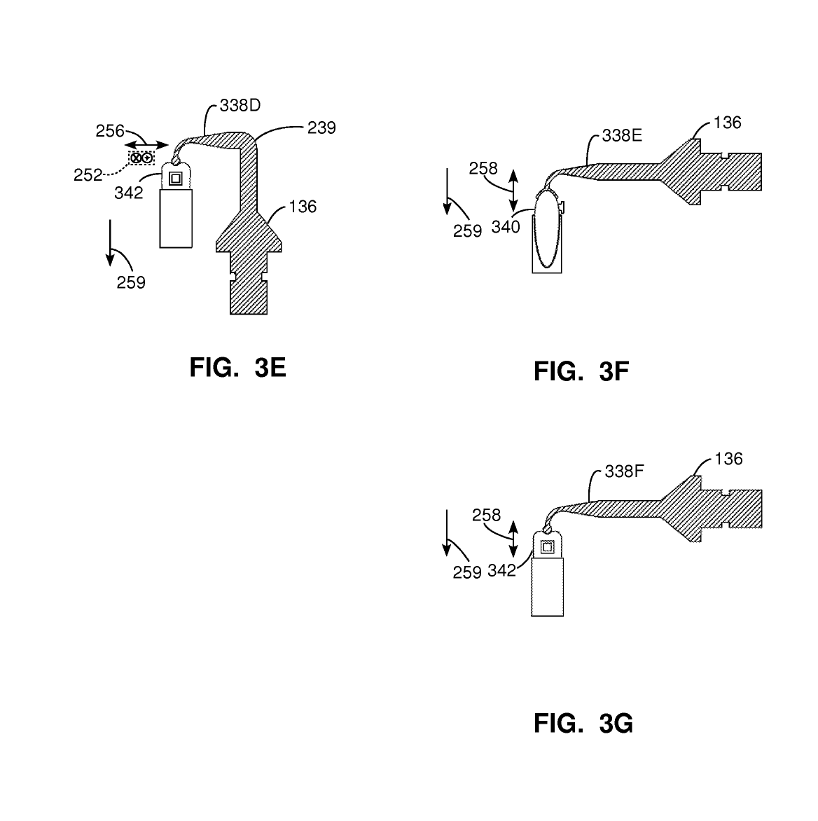

FIG. 3A-FIG. 3G depict different adapter configurations for adjusting the position of mandibular teeth. In FIG. 3A, the adapter 136 includes a probe 338A, which extends approximately perpendicularly to the adapter 136 to engage a tooth 340. In the example of FIG. 3A, the probe 338A is configured to engage the vestibular sides of incisors, canines, and premolar teeth. When connected to the orthodontic tool 100, an operator pushes the probe 338A against the tooth 340 in the lingual direction 244. The adapter 136 and probe 338A transmit vibrations from the orthodontic tool 100 to the tooth 340. In one embodiment, the probe 338A is the same probe 238A that is depicted in FIG. 2A. The tooth vibrates in the lingual and buccal directions 245 in response to the vibrations transmitted through the probe 338A.

In FIG. 3B another probe 338B includes a U-shaped end or a cap that engages the crown of the tooth 340. The U-shaped end or a cap enables the orthodontic tool 100 to apply pressure to the tooth 340 in the occlusal direction 259 while the probe 338B applies vibration to the tooth 340 in the mesial and distal directions 256. The adapter 136 approaches the incisors and canine teeth 340 depicted in FIG. 3B and the molar and premolar teeth 342 as depicted in FIG. 3C. The U-shaped end or a cap enables the probe 338B and adapter 136 to remain engaged to the tooth 340.

In FIG. 3C another probe 338D includes a rounded tip configured to engage the occlusal surface of the molar 342. The rounded tip enables the orthodontic tool 100 to apply pressure to the tooth 340 in the occlusal direction 259 while the probe 338D applies vibration to the tooth 342 in the mesial and distal directions 256. The adapter 136 approaches the molar and premolar teeth 342 and the rounded tip enables the probe 338D and adapter 136 to remain engaged to the tooth 340.

In FIG. 3D another probe 338C includes a hooked end that engages the lingual side of a tooth 340. The hooked end of the probe 338C engages the tooth 340 while an operator pulls the orthodontic tool 100 in the buccal direction 248. The adapter 136 and probe 338C transmit vibrations from the orthodontic tool 100 to the tooth 340. The tooth vibrates in the lingual and buccal directions 245 in response to the vibrations transmitted through the probe 338C.

In FIG. 3E the probe 338D is configured to engage the interior of the cusps in a molar tooth 342. When engaged to the molar 342, an operator can push on the orthodontic tool 100 apically to the crown in the occlusal direction 259. The adapter 136 and probe 338D transmit vibrations from the orthodontic tool 100 to the tooth 342 in the lingual and buccal directions 252 and in the mesial and distal directions 256. In one configuration, the probe 338D in FIG. 3E is the same probe 238D that is depicted in FIG. 2E, but the probe 338D is inverted along the longitudinal axis defined in the mesial and distal directions 256 of the portion extending past the articulation 239 to enable the probe 338D to engage the tooth 342.

In FIG. 3F another probe 338E engages an incisor, canine, or premolar tooth 340. The probe 338E includes a U-shaped end or a cap to engage the bottom of the tooth 340 in a similar manner to the probe 338B. The probe 338E, however, extends in the longitudinal axis along the length of the adapter 136 and the orthodontic tool 100 instead of including the articulation of the probe 338B. The probe 338E enables the operator to apply manual pressure on the tooth 340 in the occlusal direction 259. The orthodontic tool 100 generates vibrational forces in the apical and occlusal directions 258, and the probe 338E transmits the vibrational forces to the tooth 340. In one embodiment, the probe 338E and adapter 136 depicted in FIG. 3F are the same as probe 238E and adapter 136 depicted in FIG. 2F, and the operator rotates the orthodontic tool 100 on the longitudinal axis to orient the probe 238E/338E with the maxillary tooth 240 or mandibular tooth 340.

In FIG. 3G another probe 338F engages a molar tooth 342. The probe 338F includes a ball shaped end to engage the upper surface of the tooth 342 in a similar manner to the probe 338D. The probe 338F, however, extends in the longitudinal axis along the length of the adapter 136 and the orthodontic tool 100 instead of including the articulation 239 of probe 338D. The probe 338F enables the operator to apply manual pressure on the tooth 342 in the occlusal direction 259. The orthodontic tool 100 generates vibrational forces in the apical and occlusal directions 258, and the probe 338F transmits the vibrational forces to the tooth 342. In one embodiment, the probe 338F and adapter 136 depicted in FIG. 3G are the same as probe 238F and adapter 136 depicted in FIG. 2G, and the operator rotates the orthodontic tool 100 on the longitudinal axis to orient the probe 238F/338F with the maxillary tooth 242 or mandibular tooth 342.

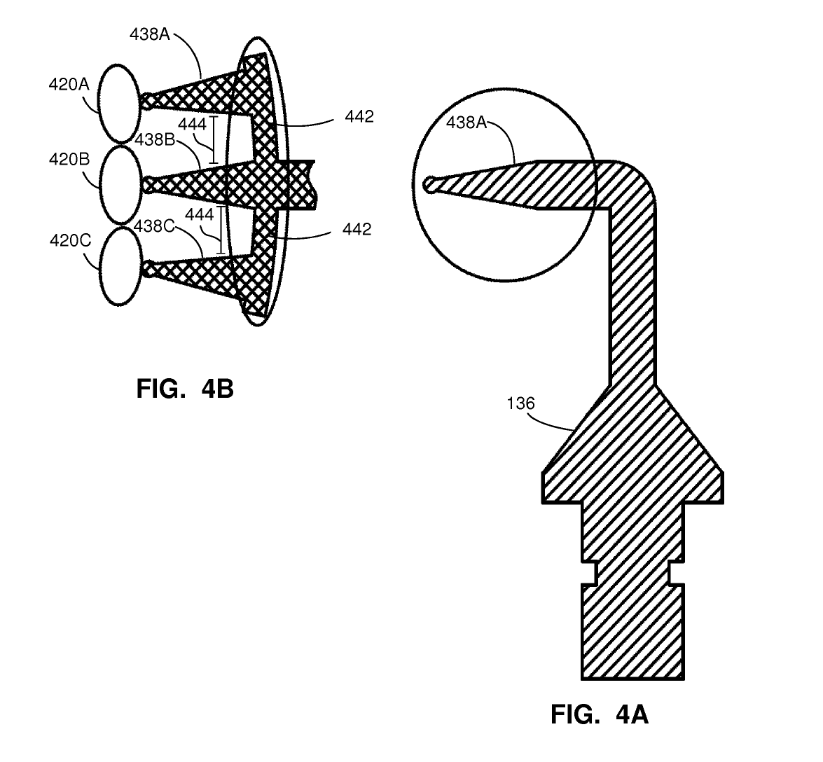

FIG. 4A and FIG. 4B depict another embodiment of the adapter 136 that engages a plurality of probes 438A-438C. The probes 438A-438C are each configured to engage one of teeth 420A-420C, respectively. In FIG. 4B, a deformable support member 442 supports each of the probes 438A-438C. The operator bends the support member 442 to enable each of the probes 438A-438C to engage one of the teeth 420A-420C. Because the curvature of teeth varies between patients, the deformable support member 442 enables the operator to adjust probes 438A-438C for each patient individually. Additionally, different sizes of the adapter 136 and probes 438A-438C include a range of different lateral spaces 444 between the probes to accommodate patients with differently sized teeth. The probes can engage adjacent teeth as depicted in FIG. 4B, or they can be spaced to engage non-adjacent teeth.

During operation, the orthodontic tool generates vibrational forces that are transmitted through the adapter 136 and each of the probes 438A-438C to the teeth 420A-420C. The multiple probes enable an operator to manipulate a group of teeth in the mouth selectively, while also minimizing the effects of the manipulation on other teeth that do not engage one of the probes 438A-438C.

While FIG. 4B depicts probes 438A-438C with designs similar to the probe 238A, alternative embodiments can include any of the probes 238A-238F, 338A-338F, or suitable combinations thereof. FIG. 4B depicts three probes, but alternative configurations of a multi-probe attachment can include two probes or four or more probes as well.

During a course of orthodontic treatment, an operator uses the orthodontic tool 100 to apply manual pressure in any of the lingual, vestibular, mesial, and distal directions. In additional to manual pressure, the orthodontic tool 100 transmits vibrational forces to the teeth. The vibrational forces applied to the teeth reduce the amount of time needed to move the teeth during orthodontic treatment, and also reduce the likelihood of root resorption and unintended misalignment of the teeth during treatment. The vibrational forces applied to an individual tooth or to selected groups of teeth enable DTMS treatment of the selected teeth while reducing or eliminating disturbances to other teeth in the mouth. Other teeth in the mouth that do not directly engage the orthodontic tool 100 are minimally affected while the orthodontic tool 100 moves the selected teeth at a faster rate during treatment. The orthodontic tool can also be used to supplement traditional orthodontic treatments such as braces, retainers, transpalatal arches, and the like. The orthodontic tool 100 accelerates the movement of selected teeth while the traditional orthodontic device continues to align the remaining teeth at a slower rate. Therefore, the vibrational force is an additional force superimposed on the teeth in addition to the regular orthodontic treatment. Thus, the orthodontic tool 100 reduces the total treatment time of a traditional orthodontic device and produces more desirable results compared to using only the traditional orthodontic device. The orthodontic tool 100 is configured to perform a variety of orthodontic treatments including, but not limited to, space closure, canine impaction, and alignment treatments.

While the preferred embodiments have been illustrated and described in detail in the drawings and foregoing description, the same should be considered illustrative and not restrictive. While preferred embodiments have been presented, all changes, modifications, and further applications are desired to be protected.

What is claimed is:

1. An orthodontic tool comprising:
a housing;
a probe extending from the housing, the probe being configured to engage a tooth; and
an electrical motor positioned in the housing, the electrical motor having an output shaft that is operatively connected to the probe, the electrical motor being configured to resonate the output shaft and probe to vibrate the tooth engaging the probe.

2. The orthodontic tool of claim 1 further comprising:
a connector configured for releasable connection to the housing and to the probe, the connector being operatively connected between the output shaft of the electrical motor and the probe to transmit vibration of the output shaft to the probe.

3. The orthodontic tool of claim 2 further comprising:
a plurality of probes, each probe being configured for releasable connection to a socket in the connector.

4. The orthodontic tool of claim 3, the plurality of probes further comprising:
a probe that bends at a right angle with reference to the output shaft of the electrical motor and terminates in a rounded tip;
a probe that bends at a right angle with reference to the output shaft of the electrical motor and terminates in a U-shaped end;
a probe that bends at a right angle with reference to the output shaft of the electrical motor and terminates in a hooked end to enable a backside of the tooth to be engaged by the probe; and
a probe that bends at a right angle with reference to the output shaft of the electrical motor and terminates in a curved end that enables a rounded tip to be placed in a cusp of the tooth.

5. The orthodontic tool of claim 4, the plurality of probes further comprising:
a probe that is aligned with the longitudinal axis of the electrical motor and terminates in a curve having a rounded tip; and
a probe that is aligned with the longitudinal axis of the electrical motor and terminates in a curve having a U-shaped end.

6. The orthodontic tool of claim 1, the probe further comprising:
a selector switch configured to generate a signal indicative of a frequency and intensity for vibration of at least one tooth; and
an electronic control unit that varies electrical power delivered to the electrical motor with reference to the signal generated by the selector switch.

7. The orthodontic tool of claim 1, the probe further comprising:
a silicone rubber covering of the probe.

8. A method of orthodontic treatment comprising:
applying a manual pressure to a tooth with an orthodontic tool; and
generating a vibrational force with an electrical motor in the orthodontic tool to vibrate the tooth while applying the manual pressure to the tooth, the vibrational force and manual pressure to accelerate movement of the tooth.

9. The method of claim 8 further comprising:
moving the tooth at a speed that is greater than a speed movement of another tooth adjacent to the tooth.

10. The method of claim 8 wherein a plurality of teeth proximate to the tooth remain substantially stationary while moving the tooth.

11. The method of claim 8 further comprising:
applying the manual pressure to a plurality of teeth with the orthodontic tool; and
generating the vibrational force with the electrical motor in the orthodontic tool to vibrate the plurality of teeth while applying the manual force to the plurality of teeth to move the teeth.

12. The method of claim 11 further comprising:
moving the plurality of teeth at a speed that is greater than a speed movement of at least one other tooth adjacent to the plurality of teeth.

13. The method of claim 11 wherein another plurality of teeth proximate to the plurality of teeth remain substantially stationary while moving the plurality of teeth.

14. The method of claim 8 further comprising:
applying the vibrational force and manual pressure to accelerate movement of the tooth with the orthodontic tool while applying a force to move the tooth and at least one other tooth with a traditional orthodontic device, the orthodontic device moving the tooth at a higher rate than the movement of the at least one other tooth.
